(19) United States
(12) Patent Application Publication
(10) Pub. No.: US 2022/0077675 A1
(43) Pub. Date: Mar. 10, 2022

(54) OVERVOLTAGE PROTECTION CIRCUIT

(71) Applicant: Global Mixed-mode Technology Inc., Hsin-Chu (TW)

(72) Inventor: Ching-Feng Lai, Taipei City (TW)

(21) Appl. No.: 17/017,665

(22) Filed: Sep. 10, 2020

(51) Int. Cl. H02H 7/09

(52) U.S. Cl. CPC H02H 7/09

(57) ABSTRACT

An overvoltage protection circuit can be applied to a motor controller. The motor controller is used for driving a motor, where the motor has a motor coil. The motor coil has a first terminal and a second terminal. The motor controller comprises the overvoltage protection circuit and a switch circuit. The switch circuit is an H-bridge circuit and includes two upper-side switches and two lower-side switches. The overvoltage protection circuit comprises a pre-driver, a phase detecting unit, a control unit, and an overvoltage detecting circuit. When an overvoltage occurs at the first terminal or the second terminal, the overvoltage protection circuit is configured to suppress a voltage spike by turning on two upper-side switches or two lower-side switches.

### BACKGROUND OF THE INVENTION

### 1. Field of the Invention

The present invention relates to an overvoltage protection circuit, and more particularly, to an overvoltage protection circuit which can be applied to a motor controller.

### 2. Description of the Prior Art

FIG. 1 is a circuit diagram showing a conventional motor controller 10. The motor controller 10 is used for driving a motor, where the motor has a motor coil L. The motor coil L has a first terminal O1 and a second terminal O2. The motor controller 10 comprises a switch circuit 100, a control unit 110, and a phase detecting unit 120. The switch circuit 100 is coupled to a terminal VCC and the terminal VCC generates a supply current IVCC. The switch circuit includes a transistor 101, a transistor 102, a transistor 103, and a transistor 104 for supplying a motor current to the motor coil L. The phase detecting unit 120 generates a phase signal Vph to the control unit 110, so as to inform the control unit 110 to switch phases. The control unit 110 generates four driving signals to the switch circuit 100, so as to respectively control the ON/OFF states of the transistor 101, the transistor 102, the transistor 103, and the transistor 104.

FIG. 2 is a timing chart showing the related signals of FIG. 1. Please refer to FIG. 1 and FIG. 2 simultaneously. When the motor is configured to operate in a forward direction, the transistor 101 and the transistor 104 are turned on while the transistor 102 and the transistor 103 are turned off. The motor current flows sequentially from the terminal VCC to the transistor 101, the first terminal O1, the second terminal O2, the transistor 104, and a terminal GND. When the motor is configured to brake or operate in a reverse direction, the transistor 102 and the transistor 103 are turned on while the transistor 101 and the transistor 104 are turned off, so as to decrease the motor current or change the direction of the motor current. At this moment the motor current keeps flowing at the same direction due to the inertia motion, resulting that the motor current flows sequentially from the terminal GND to the transistor 102, the first terminal O1, the second terminal O2, the transistor 103, and the terminal VCC. Finally, the voltage of the terminal VCC is increased and thus a voltage spike is generated. If the voltage of the terminal VCC is greater than the withstand voltage of the switch circuit 100, the switch circuit 100 may be damaged. Conventionally, a capacitor C or a Zener diode ZD may be coupled between the terminal VCC and the terminal GND, so as to absorb the excess energy or suppress the voltage spike. However, the manufacturing cost is increased by such method.

Thus, what is needed is an overvoltage protection circuit which is capable of protecting the switch circuit 100 and reducing the manufacturing cost.

### SUMMARY OF THE INVENTION

According to embodiments of the present invention, an overvoltage protection circuit which can be applied to a motor controller is provided. The motor controller is used for driving a motor, where the motor has a motor coil. The motor coil has a first terminal and a second terminal. The motor controller comprises a switch circuit and the overvoltage protection circuit, where the overvoltage protection circuit is coupled to the switch circuit for preventing the switching circuit from damage. The switch circuit is coupled to a terminal VCC and the terminal VCC generates a supply current to the switch circuit. The switch circuit is configured to supply a motor current to the motor coil, where the motor current may be analogous to the supply current. The switch circuit includes a first transistor, a second transistor, a third transistor, and a fourth transistor. Moreover, the switch circuit is an H-bridge circuit. Each of the first transistor and the third transistor is an upper-side switch while each of the second transistor and the fourth transistor is a lower-side switch.

The overvoltage protection circuit comprises a pre-driver, a phase detecting unit, a control unit, and an overvoltage detecting circuit. The phase detecting unit generates a phase signal to the control unit, so as to inform the control unit to switch phases. The overvoltage detecting circuit comprises a first resistor, a second resistor, and a comparator for generating a detecting signal to the control unit. The first resistor is coupled to the terminal VCC and the second resistor while the second resistor is coupled to a terminal GND, so as to generate a feedback voltage to the comparator. The comparator is configured to output the detecting signal by comparing the feedback voltage with a reference voltage. Thus, it is capable of using the overvoltage detecting circuit to set a pre-determined voltage for representing an overvoltage protection value of the terminal VCC. When an overvoltage occurs at the terminal VCC, it indicates that an overvoltage also occurs at the first terminal or the second terminal. Therefore, the overvoltage detecting circuit is also capable of detecting if an overvoltage occurs at the first terminal or the second terminal.

The control unit receives the phase signal and the detecting signal for generating a control signal to the pre-driver, where the control unit determines whether or not to enter an overvoltage protection mechanism according to the detecting signal. Based on the control signal, the pre-driver generates a first driving signal, a second driving signal, a third driving signal, and a fourth driving signal for respectively controlling the ON/OFF states of the first transistor, the second transistor, the third transistor, and the fourth transistor.

When the overvoltage occurs at the first terminal or the second terminal, the overvoltage protection circuit is configured to suppress a voltage spike and protect the switch circuit by turning on two upper-side switches or two lower-side switches. Since it is needless to add extra external device, the manufacturing cost can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a conventional motor controller;

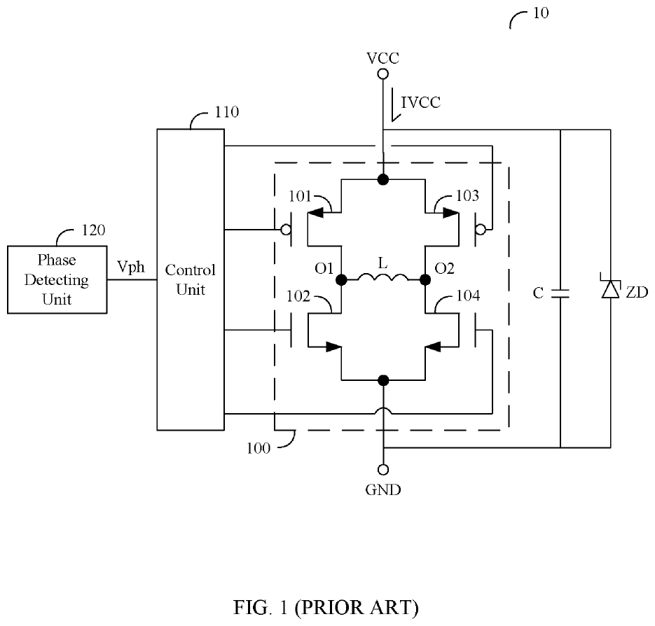

FIG. 2 is a timing chart showing the related signals of FIG. 1;

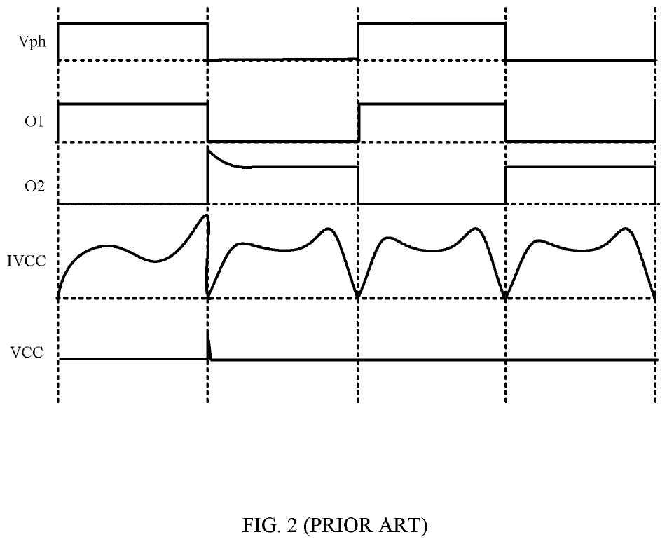

FIG. 3 is a circuit diagram showing a motor controller and an overvoltage protection circuit according to one embodiment of the present invention; and

FIG. 4 is a timing chart showing the related signals of FIG. 3 according to one embodiment of the present invention.

### DETAILED DESCRIPTION

Preferred embodiments according to the present invention will be described in detail with reference to the drawings.

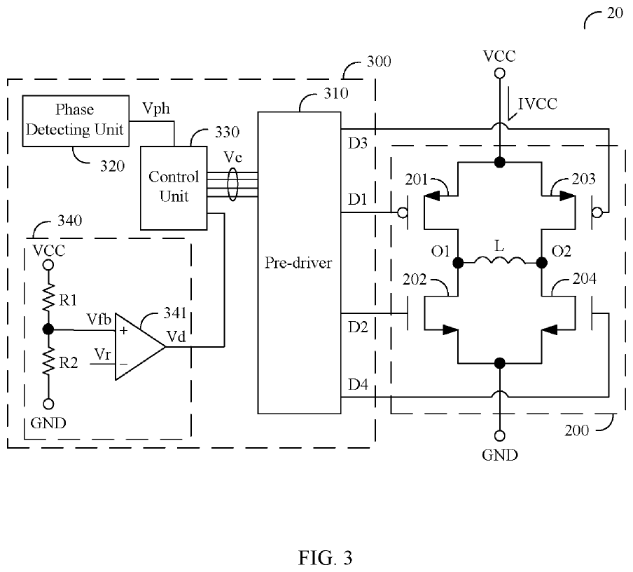

FIG. 3 is a circuit diagram showing a motor controller 20 and an overvoltage protection circuit 300 according to one embodiment of the present invention. The motor controller 20 is used for driving a motor, where the motor has a motor coil L. The motor coil L has a first terminal O1 and a second terminal O2. The motor controller 20 comprises a switch circuit 200 and the overvoltage protection circuit 300, where the overvoltage protection circuit 300 is coupled to the switch circuit 200 for preventing the switching circuit 200 from damage. The switch circuit 200 is coupled to a terminal VCC and the terminal VCC generates a supply current IVCC to the switch circuit 200. The switch circuit 200 is configured to supply a motor current to the motor coil L, where the motor current may be analogous to the supply current IVCC. The switch circuit 200 includes a first transistor 201, a second transistor 202, a third transistor 203, and a fourth transistor 204. The first transistor 201 is coupled to the terminal VCC and the first terminal O1 while the second transistor 202 is coupled to the first terminal O1 and a terminal GND. The third transistor 203 is coupled to the terminal VCC and the second terminal O2 while the fourth transistor 204 is coupled to the second terminal O2 and the terminal GND. The first transistor 201, the second transistor 202, the third transistor 203, and the fourth transistor 204 may be respectively a p-type MOSFET or an n-type MOSFET. As shown in FIG. 3, each of the first transistor 201 and the third transistor 203 may be a p-type MOSFET, while each of the second transistor 202 and the fourth transistor 204 may be an n-type MOSFET. Moreover, the switch circuit 200 is an H-bridge circuit. Each of the first transistor 201 and the third transistor 203 is an upper-side switch while each of the second transistor 202 and the fourth transistor 204 is a lower-side switch.

The overvoltage protection circuit 300 comprises a pre-driver 310, a phase detecting unit 320, a control unit 330, and an overvoltage detecting circuit 340. The phase detecting unit 320 generates a phase signal Vph to the control unit 330, so as to inform the control unit 330 to switch phases, where the phase detecting unit 320 may be a Hall sensor. The Hall sensor is placed nearby the motor for sensing the magnetic field variation of the motor. The overvoltage detecting circuit 340 comprises a first resistor R1, a second resistor R2, and a comparator 341 for generating a detecting signal Vd to the control unit 330. The first resistor R1 is coupled to the terminal VCC and the second resistor R2 while the second resistor R2 is coupled to the terminal GND, so as to generate a feedback voltage Vfb to the comparator 341. The comparator 341 is configured to output the detecting signal Vd by comparing the feedback voltage Vfb with a reference voltage Vr. Thus, it is capable of using the overvoltage detecting circuit 340 to set a pre-determined voltage for representing an overvoltage protection value of the terminal VCC. When an overvoltage occurs at the terminal VCC, it indicates that an overvoltage also occurs at the first terminal O1 or the second terminal O2. Therefore, the overvoltage detecting circuit 340 is also capable of detecting if an overvoltage occurs at the first terminal O1 or the second terminal O2.

The control unit 330 receives the phase signal Vph and the detecting signal Vd for generating a control signal Vc to the pre-driver 310, where the control unit 330 determines whether or not to start an overvoltage protection mechanism according to the detecting signal Vd. Based on the control signal Vc, the pre-driver generates a first driving signal D1, a second driving signal D2, a third driving signal D3, and a fourth driving signal D4 for respectively controlling the ON/OFF states of the first transistor 201, the second transistor 202, the third transistor 203, and the fourth transistor 204.

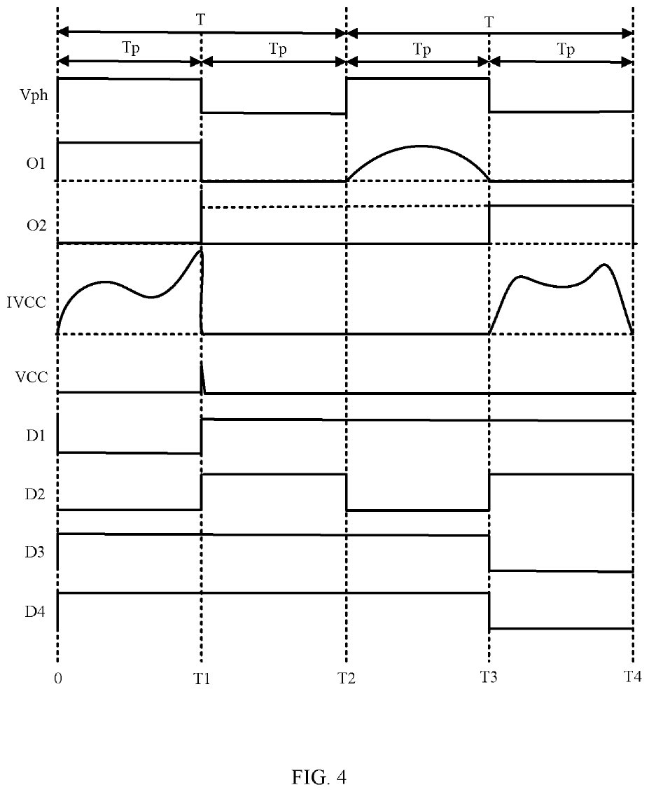

FIG. 4 is a timing chart showing the related signals of FIG. 3 according to one embodiment of the present invention. Please refer to FIG. 3 and FIG. 4 simultaneously. Since the phase signal Vph is a periodic signal with a period T, it is capable of defining a phase switching time Tp to be equal to 0.5×T. That is to say, the time interval between the time point 0 and the time point T1 is equal to the phase switching time Tp. The time interval between the time point T1 and the time point T2 is equal to the phase switching time Tp. The time interval between the time point T2 and the time point T3 is equal to the phase switching time Tp. The time interval between the time point T3 and the time point T4 is equal to the phase switching time Tp.

More specifically, when the motor operates from a forward direction state to a braking state at the time point T1, if the voltage of the terminal VCC is greater than the pre-determined value, the detecting signal Vd will be changed from a low level L to a high level H for informing the control unit 330 to start the overvoltage protection mechanism. At this moment the second transistor 202 and the fourth transistor 204 are turned on, while the first transistor 201 and the third transistor 203 are turned off, such that the voltage of the first terminal O1 and the voltage of the second terminal O2 will be forced at the low level L for suppressing the voltage spike of the second terminal O2. In addition, the turn-on time of the second transistor 202 and the fourth transistor 204 may last at least one phase switching time Td. After the turn-on time, the second transistor 202 and the fourth transistor 204 are turned off, or one of the second transistor 202 and the fourth transistor 204 is turned off, so as to end the overvoltage protection mechanism. It is needed to make sure that the motor current is equal to 0 or approaches 0 before ending the overvoltage protection mechanism for preventing the voltage spike generated again. After ending the overvoltage protection mechanism, the motor may be driven again after at least N phase switching time Tp for decreasing the temperature of the switch circuit 200, where N is greater than 1 or equal to 1 and N is a positive integer. According to another embodiment of the present invention, the first transistor 201 and the third transistor 203 may be turned on while the second transistor 202 and the fourth transistor 204 may be turned off when starting the overvoltage protection mechanism, so as to suppress the voltage spike. At the same manner, when the motor operates from a reverse direction state to the braking state, the overvoltage protection circuit 300 is also capable of suppressing the voltage spike generated at the first terminal O1.

According to one embodiment of the present invention, the overvoltage protection circuit 300 can be applied to a single-phase motor. When the overvoltage occurs at the first terminal O1 or the second terminal O2, the overvoltage protection circuit 300 is configured to suppress the voltage spike and protect the switch circuit 200 by turning on two upper-side switches or two lower-side switches. Since it is needless to add extra external device, the manufacturing cost can be reduced.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An overvoltage protection circuit configured to protect an H-bridge circuit, wherein the H-bridge circuit is used for supplying a motor current to a motor coil, the motor coil has a first terminal and a second terminal, the H-bridge circuit comprises two uppers-side switches and two lower-side switches, and the overvoltage protection circuit comprises:
a pre-driver, configured to generate a plurality of driving signals to control the H-bridge circuit; and
a control unit, configured to generate a control signal to the pre-driver, wherein when an overvoltage occurs at the first terminal or the second terminal, the two lower-side switches are turned on.

2. The overvoltage protection circuit of claim 1, wherein when the overvoltage occurs at the first terminal or the second terminal, the two upper-side switches are turned off.

3. The overvoltage protection circuit of claim 1, wherein each of the two upper-side switches is a p-type MOSFET, and each of the two lower-side switches is an n-type MOSFET.

4. The overvoltage protection circuit of claim 1, wherein the overvoltage protection circuit is applied to a single-phase motor.

5. The overvoltage protection circuit of claim 1, wherein the overvoltage protection circuit further comprises a phase detecting unit, the phase detecting unit is configured to generate a phase signal to the control unit for switching the phases, and the phase signal is a periodic signal with a period T.

6. The overvoltage protection circuit of claim 5, wherein a turn-on time of the two lower-side switches lasts at least one phase switching time, wherein the phase switching time is equal to 0.5×T.

7. The overvoltage protection circuit of claim 6, wherein the two lower-side switches are turned off after the turn-on time.

8. The overvoltage protection circuit of claim 6, wherein one of the two lower-side switches is turned off after the turn-on time.

9. An overvoltage protection circuit configured to protect an H-bridge circuit, wherein the H-bridge circuit is used for supplying a motor current to a motor coil, the motor coil has a first terminal and a second terminal, the H-bridge circuit comprises two uppers-side switches and two lower-side switches, and the overvoltage protection circuit comprises:
a pre-driver, configured to generate a plurality of driving signals to control the H-bridge circuit; and
a control unit, configured to generate a control signal to the pre-driver, wherein when an overvoltage occurs at the first terminal or the second terminal, the two upper-side switches are turned on.

10. The overvoltage protection circuit of claim 9, wherein when the overvoltage occurs at the first terminal or the second terminal, the two lower-side switches are turned off.

11. An overvoltage protection circuit configured to protect a switch circuit, wherein the switch circuit is used for supplying a motor current to a motor coil, the motor coil has a first terminal and a second terminal, the switch circuit comprises a first transistor, a second transistor, a third transistor, and a fourth transistor, the first transistor is coupled to a third terminal and the first terminal, the second transistor is coupled to the first terminal and a fourth terminal, the third transistor is coupled to the third terminal and the second terminal, the fourth transistor is coupled to the second terminal and the fourth terminal, and the overvoltage protection circuit comprises:
a pre-driver, configured to generate a plurality of driving signals to control the switch circuit;
a control unit, configured to generate a control signal to the pre-driver;
a phase detecting unit, configured to generate a phase signal to the control unit for switching the phases, where the phase signal is a periodic signal with a period T; and
an overvoltage detecting circuit, configured to generate a detecting signal to the control unit, wherein when an overvoltage occurs at the first terminal or the second terminal, the second transistor and the fourth transistor are turned on, thereby starting an overvoltage protection mechanism.

12. The overvoltage protection circuit of claim 11, wherein when the overvoltage occurs at the first terminal or the second terminal, the first transistor and the third transistor are turned off, thereby starting the overvoltage protection mechanism.

13. The overvoltage protection circuit of claim 12, wherein the overvoltage protection circuit is applied to a single-phase motor.

14. The overvoltage protection circuit of claim 13, wherein a turn-on time of the second transistor and the fourth transistor lasts at least one phase switching time, where the phase switching time is equal to 0.5×T.

15. The overvoltage protection circuit of claim 14, wherein the second transistor and the fourth transistor are turned off after the turn-on time, thereby ending the overvoltage protection mechanism.

16. The overvoltage protection circuit of claim 14, wherein one of the second transistor and the fourth transistor is turned off after the turn-on time, thereby ending the overvoltage protection mechanism.

17. The overvoltage protection circuit of claim 15, wherein after ending the overvoltage protection mechanism, the single-phase motor is driven again after at least N phase switching time, wherein N is greater than 1 or equal to 1 and N is a positive integer.

18. The overvoltage protection circuit of claim 16, wherein after ending the overvoltage protection mechanism, the single-phase motor is driven again after at least N phase switching time, wherein N is greater than 1 or equal to 1 and N is a positive integer.

19. The overvoltage protection circuit of claim 11, wherein the overvoltage detecting circuit comprises:
a first resistor, coupled to the third terminal;
a second resistor, coupled to the first resistor and the fourth terminal for generating a feedback voltage; and
a comparator, configured to output the detecting signal by comparing the feedback voltage with a reference voltage.

20. The overvoltage protection circuit of claim 11, wherein each of the first transistor and the third transistor is a p-type MOSFET, and each of the second transistor and the fourth is an n-type MOSFET.
